(19) United States
(12) Patent Application Publication
(10) Pub. No.: US 2022/0199071 A1
(43) Pub. Date: Jun. 23, 2022

(54) Systems and Methods for Speech Validation

(71) Applicant: Ello Technology, Inc., San Francisco, CA (US)

(72) Inventors: Catalin Voss, San Francisco, CA (US); Thomas Robert Sayer, San Francisco, CA (US); Anish Nag, San Francisco, CA (US)

(73) Assignee: Ello Technology, Inc., San Francisco, CA (US)

(21) Appl. No.: 17/644,767

(22) Filed: Dec. 16, 2021

Related U.S. Application Data
(60) Provisional application No. 63/187,260, filed on May 11, 2021.
(60) Provisional application No. 63/130,248, filed on Dec. 23, 2020.

(51) Int. Cl. G10L 15/02; G10L 15/19

(52) U.S. Cl. CPC G10L 15/02; G10L 2015/025; G10L 15/19

(57) ABSTRACT

Systems and methods for speech validation in accordance with embodiments of the invention are illustrated. One embodiment includes a method for validating speech. The method includes steps for encoding a set of audio data, processing a set of target data, wherein the target data includes a sequence of target elements associated with the set of audio data, computing a set of one or more alignment probabilities for each target element of the sequence of target elements, performing temporal resolution based on the computed set of alignment probabilities to determine an alignment between the set of target data and the set of audio data.

### CROSS-REFERENCE TO RELATED APPLICATIONS

The current application claims the benefit of and priority under 35 U.S.C. § 119(e) to U.S. Provisional Patent Application No. 63/187,260 filed May 11, 2021 and entitled “Systems and Methods for Speech Validation,” and U.S. Provisional Patent Application No. 63/130,248 filed Dec. 23, 2020 and entitled “Real-time On-Device Speech Validation for Child Literacy,” the disclosures of which are hereby incorporated by reference their entireties by reference.

### FIELD OF THE INVENTION

The present invention generally relates to speech validation and, more specifically, speech validation with position tracking.

### BACKGROUND

It can be difficult for students to learn to read independently, as they are often unable to get the individual attention necessary to help them along their learning path. An automated system for evaluating a reader and providing instruction may be desirable, but it can be difficult for automated systems to correctly interpret and correct a reader as they are reading. It is particularly challenging to develop a system that can simultaneously score the pronunciation of individual words to produce feedback and keep track with the pace of a reader. Several mispronunciation detection systems take a “record-then-review” approach, but this does not allow for a fluent user experience that teaches reading within continuous text. Validating speech online remains a challenging task. New readers may mispronounce words, jump around within the text, or skip words completely, which can pose difficulties for existing automatic speech recognition and keyword spotting models that rely on language models or closed vocabularies. Systems and methods that address these problems and allow for continuous speech validation in such open-vocabulary settings may have applications beyond teaching reading.

### SUMMARY OF THE INVENTION

Systems and methods for speech validation in accordance with embodiments of the invention are illustrated. One embodiment includes a method for validating speech. The method includes steps for encoding a set of audio data, processing a set of target data, wherein the target data includes a sequence of target elements associated with the set of audio data, and computing a set of one or more alignment probabilities for each target element of the sequence of target elements. The method further includes steps for performing temporal resolution based on the computed set of alignment probabilities to determine an alignment between the set of target data and the set of audio data.

In a further embodiment, encoding the set of audio data includes generating at least one selected from the group consisting of acoustic feature vectors, mel-frequency cepstral coefficients (MFCC), spectrogram data, and neural embeddings.

In still another embodiment, encoding the set of audio data can be performed using at least one selected from the group consisting of a recurrent neural network, a transformer model, and a convolutional neural network.

In a still further embodiment, processing the set of target data includes transforming the set of target data from character representations to phonetic representations.

In yet another embodiment, transforming the set of target data includes at least one selected from the group consisting of performing a lookup in a phoneme dictionary and using a phonetic decoder.

In a yet further embodiment, each target element of the set of target elements is a word and computing the set of alignment probabilities for each target element includes computing temporal probability output vectors for each word.

In another additional embodiment, encoding a set of audio data includes utilizing a neural network trained with at least one selected from the group consisting of an Audio Segmentation Criterion (ASG), a Hidden Markov Model (HMM) with explicit alignment, and a connectionist temporal classification (CTC) loss function.

In a further additional embodiment, computing the set of alignment probabilities further includes normalizing the computed set of correspondence scores.

In another embodiment again, normalizing the computed set of correspondence scores comprises normalizing for information content, and performing empirical normalization based on a set of validation data.

In a further embodiment again, computing the set of alignment probabilities includes using a single fixed buffer to compute a probability of a set of one or more words occurring in the buffer for each of several timesteps.

In still yet another embodiment, computing the set of alignment probabilities further comprises identifying a set of positive examples, and performing empirical normalization based on the set of positive examples.

In a still yet further embodiment, computing the set of alignment probabilities comprises building a matrix and computing the maximum cumulative log probability sum for transitions each of several graphemes at each of several time steps.

In still another additional embodiment, a part of the matrix defines the maximum probability log probability associated with aligning a target element to an interval.

In a still further additional embodiment, computing the set of alignment probabilities includes using a template matching process to measure the similarity of a section of the audio data with a template for audio data known to contain a target word.

In still another embodiment again, the method further includes steps for creating the template using template averaging with time warping.

In a still further embodiment again, computing the set of alignment probabilities comprises identifying target elements of the target sequence as blanks and non-blanks, and performing normalization through a summation of values, where the sum only includes target elements of the sequence of target elements that are identified as non-blanks.

In yet another additional embodiment, computing the set of alignment probabilities includes computing a likelihood ratio between a probability of the sequence of target elements and a probability of a most likely alternative transcription based on a language model.

In a yet further additional embodiment, computing the set of alignment probabilities comprises appending a separator character to each target element of the sequence, matching target elements with the encoded data based on the separator character, and computing a score for each target element, wherein the computed score does not include the separator character.

In yet another embodiment again, the method further includes steps for normalizing the computed set of alignment probabilities.

In a yet further embodiment again, normalizing the computed set of alignment probabilities includes normalizing for based on at least one selected from the group consisting of target word length, non-blank predictions, and a best alternative transcription identified with a language model.

In another additional embodiment again, normalizing the computed set of alignment probabilities includes clamping probabilities to cap scores for target elements.

In a further additional embodiment again, the method further includes steps for normalizing the alignment between the set of target data and the set of audio data.

In still yet another additional embodiment, normalizing the alignment between the set of target data and the set of audio data includes using a language model by computing a likelihood ratio between the probability of the target sequence and the probability of the most likely alternative transcription that is congruent with the language model.

In a further embodiment, performing temporal resolution includes using a bag of words approach.

In still another embodiment, performing temporal resolution includes determining alignments of encoded audio and the sequence of target elements using several cursors at different positions in the sequence of target elements.

In a still further embodiment, performing temporal resolution includes maximizing a probability sum of a sequence of target elements according to a set of one or more constraints, wherein the set of constraints includes at least one selected from the group consisting of a number of words that can be missed and a penalty for skipping.

In yet another embodiment, performing temporal resolution comprises identifying a set of one or more anchor elements from the sequence of target elements based on the set of alignment probabilities, wherein the anchor elements have higher correspondence scores than non-anchor elements, and identifying an alignment of the sequence of target elements based on the set of anchor elements.

In a yet further embodiment, performing temporal resolution includes resolving a position estimate by computing a normalized score sum for each of several potential positions in the set of target data, where each normalized score is normalized by the particular potential position, and identifying an alignment that corresponds to a highest normalized score sum of the computed score sums for the largest potential position that brings the score above a certain threshold.

In another additional embodiment, the method further includes steps for providing an interface for guiding a reader through the set of target data based on the determined alignment.

In a further additional embodiment, processing the set of target data includes defining a decoding grammar over the encoded set of audio data to generate a set of predicted words.

In another embodiment again, defining the decoding grammar is performed utilizing a set of one or more Finite State Transducers (FSTs) includes at least one FST graph that describes the probability of transitioning from one state to another state given at least a portion of the encoded set of audio data and an acceptor that encodes a grammar.

In a further embodiment again, the grammar is an n-gram grammar inferred from the target sequence and an out-of-vocabulary symbol.

In still yet another embodiment, the acceptor includes a graph with at least two partitions, wherein a first partition proceeds through the targets in order with high probability and a second partition proceeds through alternative incorrect words.

In a still yet further embodiment, computing the set of alignment probabilities includes creating a mapping between the predicted words and the target elements.

In still another additional embodiment, creating the mapping includes using a fuzzy string similarity metric to find a best match between the predicted words and the target elements.

One embodiment includes a non-transitory machine readable medium containing processor instructions for validating speech, where execution of the instructions by a processor causes the processor to perform a process that comprises encoding a set of audio data, processing a set of target data, wherein the target data includes a sequence of target elements associated with the set of audio data, and computing a set of one or more alignment probabilities for each target element of the sequence of target elements. The process further comprises performing temporal resolution based on the computed set of alignment probabilities to determine an alignment between the set of target data and the set of audio data.

One embodiment includes a system for validating speech, the system comprising a set of one or more processors, and a non-transitory machine readable medium containing processor instructions for validating speech. Execution of the instructions by the set of processors causes the processor to perform a process that comprises encoding a set of audio data, processing a set of target data, wherein the target data includes a sequence of target elements associated with the set of audio data, computing a set of one or more alignment probabilities for each target element of the sequence of target elements. The process further comprises performing temporal resolution based on the computed set of alignment probabilities to determine an alignment between the set of target data and the set of audio data.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 conceptually illustrates an example of a process for validating speech in accordance with an embodiment of the invention.

FIG. 2 conceptually illustrates an example of a process for determining alignments and performing continuous speech validation in accordance with an embodiment of the invention.

FIGS. 3A-B illustrate an example of alignment and temporal resolution in accordance with an embodiment of the invention.

FIG. 4 illustrates an example of a speech validation system that validates speech in accordance with an embodiment of the invention.

FIG. 5 illustrates an example of a speech validation element that executes instructions to perform processes that validate speech in accordance with an embodiment of the invention.

FIG. 6 illustrates an example of a speech validation application for validating speech in accordance with an embodiment of the invention.

### DETAILED DESCRIPTION

Turning now to the drawings, systems and methods in accordance with many embodiments of the invention can utilize novel techniques to more accurately identify a reader's position within a text, as well as to determine the accuracy of their reading. In various embodiments, speech validation systems can be used to provide feedback to a reader, assisting them with corrections and pronunciation, motivating them along their learning journey, and/or engaging them with extension content using information about their position in the text. Speech validation systems in accordance with certain embodiments of the invention can allow a computer system to accurately and efficiently track and/or evaluate audio (e.g., of a reader) as it proceeds through an associated text.

### A. Pipeline Outline

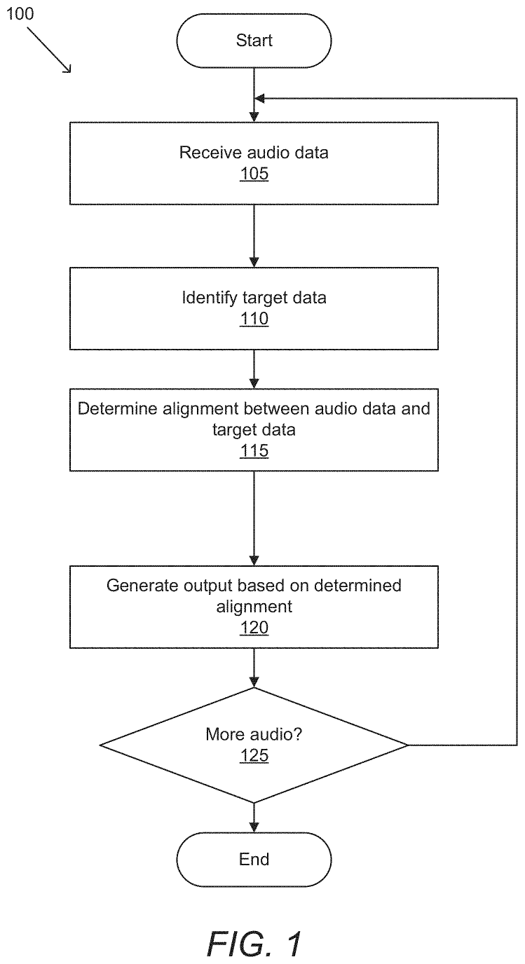

An example of a process for validating speech in accordance with an embodiment of the invention is illustrated in FIG. 1. Process 100 receives (105) audio data. Audio data in accordance with several embodiments of the invention can include (but is not limited to) raw audio data, feature vectors derived from audio data, such as mel-frequency cepstral coefficients (MFCC), spectrogram data, neural embeddings (e.g., from a convolutional encoder network), etc.

Process 100 identifies (110) target data. Target data in accordance with some embodiments of the invention can include text sequences or phonetic transcriptions associated with the audio data. For example, target data in accordance with many embodiments of the invention can include text from a book where the audio data is from a reader of the text. Target sequences in accordance with many embodiments of the invention can include text for a whole book, a chapter, a paragraph, a sentence, an individual word, a component of a word, a phoneme, etc. In certain embodiments, target data can include various text associated with audio, such as (but not limited to) transcripts, scripts, closed captions, etc. Although many of the examples described herein refer to examples of sequences of words, one skilled in the art will recognize that similar systems and methods can be used in a variety of applications, including (but not limited to) phonetic sequences, without departing from this invention.

Process 100 determines (115) an alignment between the audio data and the target data. Determining alignments in accordance with several embodiments of the invention can include various stages, such as (but not limited to) determining start and end times for each word, deriving probabilities and/or scores from the start and end times for each word, estimating a position based on the above, etc. In various embodiments, rather than explicitly determining an alignment, processes may determine predicted positions as the audio data moves through the target data, creating an implicit alignment between the audio data and the target data.

Alignments in accordance with some embodiments of the invention can include start and/or end times for each word, a set of one or more potential alignments, an optimal alignment, a single position estimate or multiple position estimates, etc. In a number of embodiments, alignments can include data that indicates scores and/or probabilities for a given alignment, and/or a predicted position or timespan within the target data. Alignment probabilities in accordance with a number of embodiments of the invention can indicate one or more of the likelihoods of each word, character, phoneme or other grapheme in the target data, likelihoods of sequences of words in the target data, etc.

Processes in accordance with numerous embodiments of the invention can determine alignments between the audio data and the target in a number of different ways, which are described in further detail in the next section. In certain embodiments, processes can predict text based on the audio data, and alignments can be determined based on similarities between the predicted text and the target text.

In some embodiments, alignment probabilities can be resolved to an output position, estimated using different probability aggregation strategies. For example, given a vector of probabilities of the same length as the target words, with the jth score corresponding to an estimate of the likelihood that a reader has progressed through the first j targets, processes in accordance with many embodiments of the invention can find the j that enables the furthest allowable position under some constraints. Processes consistent with some embodiments of the invention may compute the position estimate as the j that provides the largest group mean score for targets to the left of the jth target, for which the group mean score is above the threshold. In other embodiments, processes may require all scores up to j to be above the threshold. In yet other embodiments, processes may explicitly utilize rules. For example, processes in accordance with some embodiments of the invention may define rules that allow a maximum number of skipped words, etc., to estimate the position.

Processes in accordance with various embodiments of the invention can determine alignments and positions by searching for alignments or hypothesized positions around multiple cursors, where potential alignments for the audio data can be computed for various positions in the target text, or vice versa. In a variety of embodiments, processes can determine an alignment between the audio data and each word in target data. Processes in accordance with several embodiments of the invention can determine an alignment between the audio data and an ordered sequence of target words in the target data. Determining alignments between audio data and target data is described in greater detail below.

Process 100 generates (120) output based on the determined alignment. In some embodiments, outputs can include scores for the audio data, where determined alignments can be used to generate scores for the audio data associated with the target data. Scoring in accordance with certain embodiments of the invention can measure the performance of a reader along various measures, such as (but not limited to) accuracy, completeness, speed, etc. For example, processes in accordance with some embodiments of the invention can include scores that indicate performance on reading for individual phonemes, for subcomponents of words, for entire words, for a sequence of words, etc. In many embodiments, processes can generate outputs that can be used to indicate (e.g., via a user interface) progress for a user as they read through a target text, problem words that a user may have struggled with or missed, etc. In numerous embodiments, alignment outputs can be used to provide additional exercises or other assistance to help a reader along.

Additional metadata that can be useful for providing reading instruction may also be returned from the process. Some of that data may be useful to provide an interactive teaching experience even if some of the prior speech validation steps were not able to be performed successfully. For example, vocal activity detection may be performed and even when the target sequence was not identified, processes in accordance with various embodiments of the invention may return other information about a session, such as (but not limited to) the number of words uttered, a probability score indicating whether an audio sequence contained any speech at all, etc. In many embodiments, metadata and/or alignment outputs may be used to provide motivational content to a reader.

In a variety of embodiments, speech validation processes can be performed in an online manner, updating alignments, outputs, and/or scores as more audio data is received. Process 100 determines (125) whether there is more audio to be processed. When process 100 determines that there is additional audio, process 100 returns to step 105 to receive the new audio data. When process 100 determines (125) that there is no more audio, the process ends.

While specific processes for validating speech are described above, any of a variety of processes can be utilized to validate speech as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

For example, although the example of this figure provides separate steps for determining alignments and generating outputs, processes in accordance with certain embodiments of the invention may produce alignments and/or outputs using an end-to-end model (e.g., a neural transducer model trained on fully supervised alignment data). At each time step, end-to-end models in accordance with various embodiments of the invention could determine whether to advance the position(s) within a target text. End-to-end models in accordance with a number of embodiments of the invention could essentially perform all of the steps of this pipeline in a single obscure black-box neural network.

Although the above embodiments of the invention are described in reference to reading assistance for new readers, the techniques disclosed herein may be used in any type of speech validation, including (but not limited to) speech therapy, closed caption evaluation, intelligent digital assistants, etc.

### B. Continuous Keyword Spotting and Alignment Computation

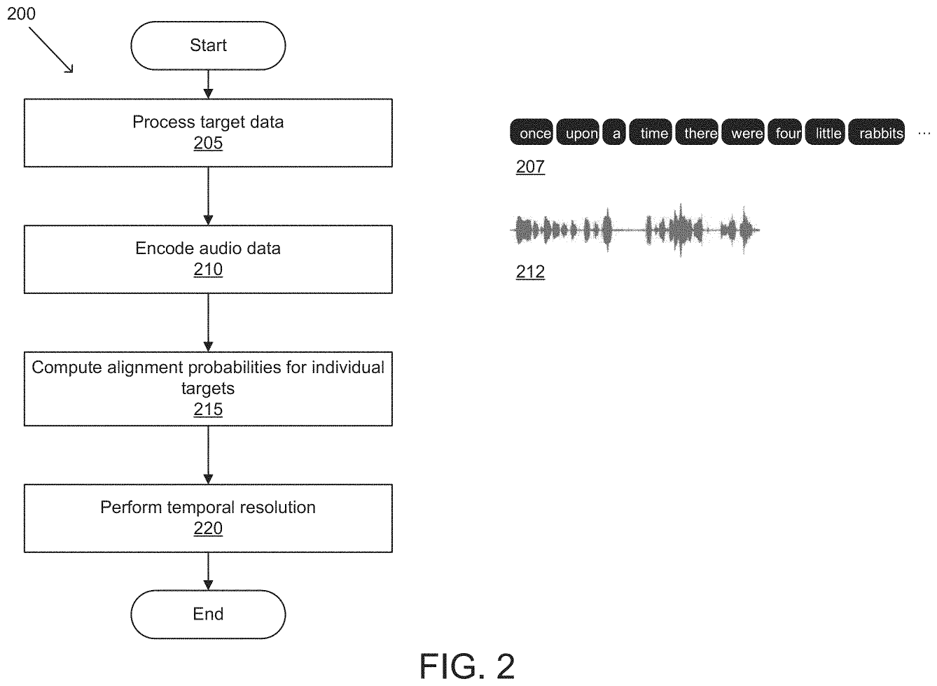

An example of a process for determining alignments and performing continuous speech validation in accordance with an embodiment of the invention is illustrated in FIG. 2. Process 200 processes (205) target data. Processing (or encoding) target data may include transforming the data into a different alphabet over which the alignment performed. In some embodiments, performance may be improved by computing alignments over phonetic representations rather than character representations of language. In such cases, target data may be encoded by looking up a representation of an input target in a phoneme dictionary and/or using a phonetic decoder to transform characters into phonemes or other graphemes (e.g., combinations of phonemes). To improve performance, some of these encoding steps over the targets may be performed in advance so that the already-encoded targets are passed into the process so that less or no further encoding is required at runtime. An example of target data 207 shows a sequence of words that are to be read by a reader. Target words may constitute individual words, word-pieces, multi-word sequences, hyphenations (e.g. “sixty-four”), individual phonemes, abbreviations, individual letters, etc.

Process 200 encodes (210) audio data. In some embodiments, audio data can be encoded to various formats, such as (but not limited to) vectors of acoustic features derived from audio data, mel-frequency cepstral coefficients (MFCC), spectrogram data, neural embeddings, etc. Encoding target data in accordance with numerous embodiments of the invention may also include normalizing words, performing certain pruning removing punctuation and/or stopwords, and/or other common pre-processing tasks. An example of audio data 212 shows an audio graph of audio that is to be aligned with the target data.

Encoding audio data in accordance with numerous embodiments of the invention can be performed using various methods and/or acoustic models, including (but not limited to) recurrent neural networks (RNNs) such as long short-term memory (LSTM) models or models using gated recurrent units (GRUs), transformer models, fully or partially convolutional neural networks (CNNs), etc. In various embodiments, suitable neural networks may have been pre-trained with supervision for auxiliary tasks, such as Automatic Speech Recognition (ASR), keyword spotting (KWS), vocal activity detection (VAD), etc. Neural networks in accordance with numerous embodiments of the invention may have been pre-trained in a self-supervised manner on raw audio or audio features (e.g., following the approach of wav2vec (Schneider et al. 2019) or wav2vec 2.0 (Baevski et al. 2020)). Depending on the choice of encoder model, models in accordance with several embodiments of the invention may exhibit explicit certain network dynamics, where a language model is unintentionally baked into a model because it favors words that it has been trained on. Processes in accordance with some embodiments of the invention can account for such explicit model network dynamics when encoding audio and/or when computing correspondence (or confidence) scores.

Correspondence scores in accordance with several embodiments of the invention can indicate the correspondence between target data and related audio data.

Encoded target and audio data in accordance with certain embodiments of the invention may be brought into a shared numerical space that is temporally disjoint. For example, in some embodiments of the invention, target words can be transformed into a grapheme/phoneme sequence (e.g. “rabbits” is turned into “R AE1 B AH0 T S” in an ARPABET transcription) and the audio signal can be transformed into an array of probability vectors, where for each timestep, the vector indicates the probability of a given grapheme or phoneme for that timestep. Temporal probability vectors (or tokens) in accordance with many embodiments of the invention can indicate probabilities for each element of an alphabet at various time steps. Alphabets in accordance with numerous embodiments of the invention can include characters, phonemes, blanks, spaces, punctuation, etc. or any custom grapheme alphabet that can act as the constituents of language.

Suitable models for producing such temporal probability output vectors for the audio signal may include (but are not limited to) neural networks trained using loss functions such as Connectionist Temporal Classification (CTC; see “Connectionist Temporal Classification: Labelling Unsegmented Sequence Data with Recurrent Neural Networks” by Alex Graves, Santiago Fern, Faustino Gomez, and Jürgen Schmidhuber), which integrates out alignment, or the Guided Attention Loss (see “Efficiently Trainable Text-to-Speech System Based on Deep Convolutional Networks with Guided Attention” by Hideyuki Tachibana, Katsuya Uenoyama, Shunsuke Aihara) or the Audio Segmentation Criterion (ASG; see “Wav2Letter: an End-to-End ConvNet-based Speech Recognition System” by Ronan Collobert and Christian Puhrsch), which preserves more alignment information, or hybrid models utilizing Hidden Markov Models (HMMs) with explicit alignment. Given the alignment objective of the downstream task, models that preserve alignment information may generally be preferrable.

Process 200 computes (215) alignment probabilities for individual targets. In many embodiments, computing alignment probabilities can identify targets in the temporal sequence. In some embodiments, correspondence scores can be continuously computed as tokens are generated from audio data. In numerous embodiments, computing alignment probabilities and/or performing temporal resolution can include performing various normalization processes. Normalization processes in accordance with various embodiments of the invention can utilize normalizations for information content and/or empirical normalization techniques.

Process 200 performs (220) temporal resolution to determine the alignment between the target data and the encoded audio data. Determined alignments in accordance with several embodiments of the invention can include (but are not limited to) predicted position(s) within the target sequence, target probabilities, etc. In some embodiments, performing temporal resolution can include updating cursors for different positions within the target data.

While specific processes for determining alignments and performing continuous speech validation are described above, any of a variety of processes can be utilized to determine alignments and/or perform speech validation as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

1. Generative, ASR-Based Methods

In some embodiments, processes may employ adapted versions of decoders commonly used for ASR or KWS tasks to produce alignments. Such processes are “generative” in nature in that they fix a possibly constrained decoding graph upfront and then “listen” for the words spoken in a stateful manner, and finally align the generated word-level outputs with the target sequence.

a. Generating Predictions

Processes in accordance with numerous embodiments of the invention can utilize Finite State Transducers (FSTs) to define a decoding grammar over model encoding outputs, phonemes, graphemes, and/or words or word-pieces. The FST graph describes the probability of transitioning from one state to another state given the observed element (e.g., audio symbol encoding output, phoneme, word, etc.) at each step. Some states are terminal and cause the model to make predictions. For ASR applications in accordance with a variety of embodiments of the invention, multiple FSTs can be chained together, with the final FST representing an acceptor that encodes a language model grammar for open-domain speech recognition.

Processes in accordance with some embodiments of the invention may define a custom acceptor FST based on the target sequence. In some embodiments, the acceptor may be an n-gram grammar inferred from the target sequence and an [unk] out-of-vocabulary symbol. In a variety of embodiments, acceptors may comprise a graph with two main partitions: one proceeding through the targets in order with high probability and another one proceeding through alternative incorrect words (a “noise highway” through the decoder), with skip and repetition transitions and transitions between the two partitions configured to allow for the allowed reading patterns (e.g. reading with arbitrary insertions).

When the target sequence consists of a single word, the generative prediction problem becomes discriminative in nature; for example an n-gram-inferred decoding graph would only be distinguishing between the relevant word and the [unk] symbol. To improve recognition performance in such cases, processes in accordance with a number of embodiments of the invention may provide for special-case handling of single- or few-word alignments by including a fixed number of alternative incorrect words in the decoding graph. These may include common mistakes identified empirically.

Processes in accordance with many embodiments of the invention can utilize beam search over grapheme or phoneme probability vectors such as CTC tokens to generate predictions. ASR approaches using beam search usually explicitly or implicitly employ a language model in order to produce the most likely transcription of the audio signal in a given language. In such cases, the performance of systems in accordance with various embodiments of the invention can be improved by modifying the ASR system to remove or restrict the effect of the language model (e.g., by removing its language model from the scoring step or restricting its language model to a smaller subset of words than is commonly used for open-domain ASR consistent with the targets, etc.). Modifying the beam search procedure in such a way can improve the likelihood of uncovering the target sequence within a lattice of options, especially if the target sequence contains rare words that are unlikely to be predicted by an end-to-end ASR system.

Processes in accordance with various embodiments of the invention can utilize a conditioned neural acoustic model to predict candidate words. This can be achieved by modifying a neural network intended for end-to-end ASR to refer to embeddings derived from the target sequence directly at train-time. Training in accordance with several embodiments of the invention may be done in conjunction with the original ASR objective. For example, building on a transformer-based neural acoustic model, models can be augmented with a small language encoder model into which the target sequence is fed. The last few attention layers of a model can then be modified to attend to the target sequence in addition to the acoustic embeddings to produce the outputs. The ASR training procedure differs in the training data: rather than training with transcriptions of speech alone, this model can be trained—or fine-tuned from a pre-trained model—using both a desired transcription passed into the targets arm and a spoken transcription used with the original training objective, such as CTC. In some embodiments, such training data can be synthetically generated from existing supervised ASR data by perturbing the spoken transcription to form a synthetic desired transcription for examples with artificial reading errors.

In certain embodiments, processes can effectively employ Automatic Speech Recognition (ASR) as a black-box sub-routine without modification and perform alignment and temporal resolution at once over a single text-to-speech output or search for pronunciation templates in a lattice of transcription candidates. In a simple implementation of such embodiments, the output of target encoding can include one or more target transcriptions for a given word and the encoded audio can be a single transcription of speech.

b. Resolving the Alignment from the Predictions

Computing alignment probabilities in accordance with numerous embodiments of the invention involves creating a mapping between the words that the ASR system transcribed and the target words.

In several embodiments, computing alignment probabilities may employ a fuzzy string similarity metric to find the best match between words and the target sequence, advancing to a position when it finds a sufficient match. For example, define mᵢⱼ to be the match score between candidate word i and target j, such that mᵢⱼ is higher if the match is stronger and mᵢⱼ=1 if and only if i and j correspond to the same word. In some embodiments, the prediction confidence in the ith candidate word from the acoustic model may also be incorporated into the score mᵢⱼ.

Define zᵢⱼ to be the max attainable score by assigning all candidate words≤j to targets≤i (or not assigning them, i.e. skipping them). This allows for deriving a dynamic programming algorithm to determine zᵢⱼ and the alignment that produces it for each i,j as follows.

If the ith candidate can be assigned to the jth target, the following options can be used to achieve a max score:
Create an edge between i and j. Then that edge has value mᵢⱼ and since no other candidate is allowed to point to target j and candidate i has been used, the remainder is z_{i-1,j-1}
Ignore the jth target. Instead, map the ith candidate to any target≤j−1, so the remainder is z_{i-1,j-1}.
Ignore the ith candidate because we achieve higher value by mapping one of the candidates≤i−1 to target j. In this case we have the remainder z_{i-1,j}.

A dynamic programming implementation of such a recursion is given by:
z₁₁←m₁₁
zᵢⱼ←max{m₁₁+z_{i-1,j-1}, z_{i,j-1}, z_{i-1,j}}

The dynamic programming algorithm can be trivially extended to track the best alignment πᵢⱼ* corresponding to the highest total score path for mapping only the first i predictions to targets through the jth one.

Several aggregation methods can be applied to identify the best alignment and estimate a reading position from the set of all πᵢⱼ* and zᵢⱼ. Stable alignments may be desirable for the position estimate to not jump erratically when additional predictions change the zᵢⱼs. A particularly stable estimate can be achieved in accordance with several embodiments of the invention by defining the optimal alignment to be the alignment which corresponds to highest score sum for the largest possible j that brings the score through j (normalized by j itself the number of mapped targets) above a certain threshold. Intuitively, this corresponds to allowing a reader to make up for an earlier error by reading multiple correct words later on with a smooth taper. Formally, given N targets and K prediction candidates, this approach chooses

$${j}^{*} = \frac{max {z}_{K j}}{j} .$$

The optimal alignment then is given by π_{Kj*}*, and the sequence

$${m}_{{π}_{{Kj}_{1}^{*}}^{*}} , {m}_{{π}_{{Kj}_{2}^{*}}^{*}} , {m}_{{π}_{{Kj}_{3}^{*}}^{*}} ,$$

. . . gives the stepwise probabilities for this alignment which can be used to estimate the probabilities of errors during reading.

Although many of the examples of alignment and estimating reading positions described herein are described with reference to generative or discriminative methods, one skilled in the art will recognize that similar processes can be used in both discriminative and generative methods without departing from this invention.

In certain embodiments, processes in accordance with many embodiments of the invention can use generative ASR-based methods in conjunction with processes for discriminative alignment methods with temporal resolution as described below. For example, processes in accordance with a number of embodiments of the invention may use ASR-based methods with a restricted language model while listening for a small number (e.g., 1-3) of words at a time and use multiple cursors for position resolution. Other embodiments may use generative methods to estimate a reader's position but run a discriminative re-scoring pass after completion of the sequence in order to get more accurate pronunciation scoring outputs.

2. Discriminative Alignment Methods with Temporal Resolution

A potential drawback of methods that perform alignment at the word-level after full ASR decoding is that rare target sequences can sometimes not be found within the output transcription after decoding. This follows from the generative design of the model—the ASR model is asked to answer the question “What was the most likely spoken sequence given this audio?” This is a hard task. Even human reading experts are often unable to correctly predict the raw word sequence in a children's book when listening to a child reading. However, they are perfectly able to follow along when looking at the words in the book. In numerous embodiments, processes for performing alignment and speech validation over raw tokens can avoid such limitations. Such methods are discriminative in nature—they explicitly ask the question “How well does what was spoken line up with the target sequence?”

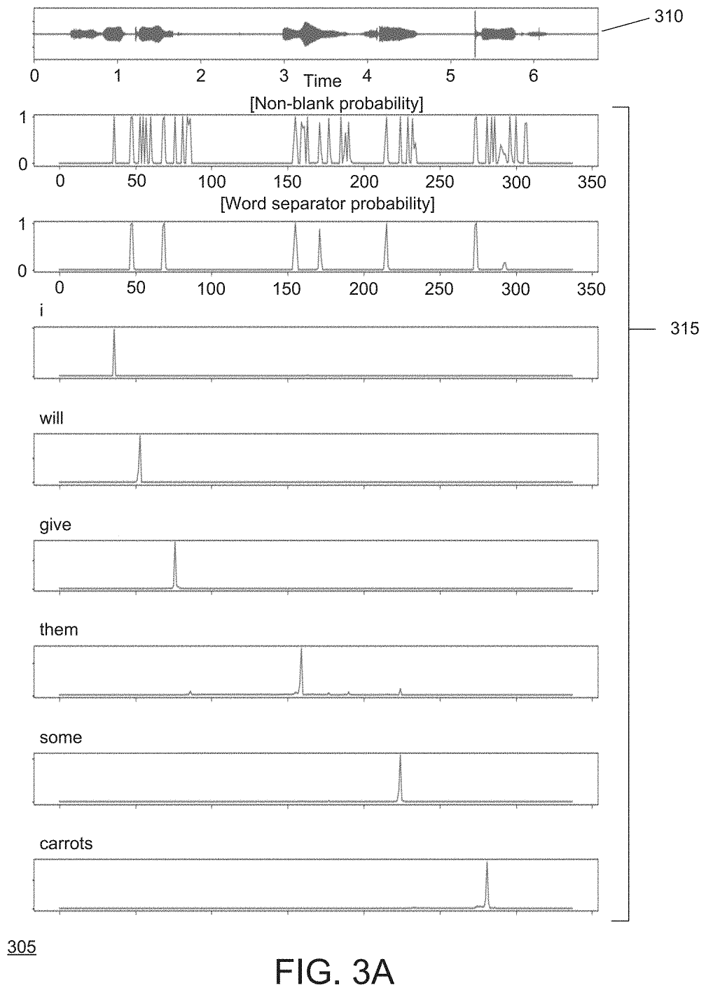

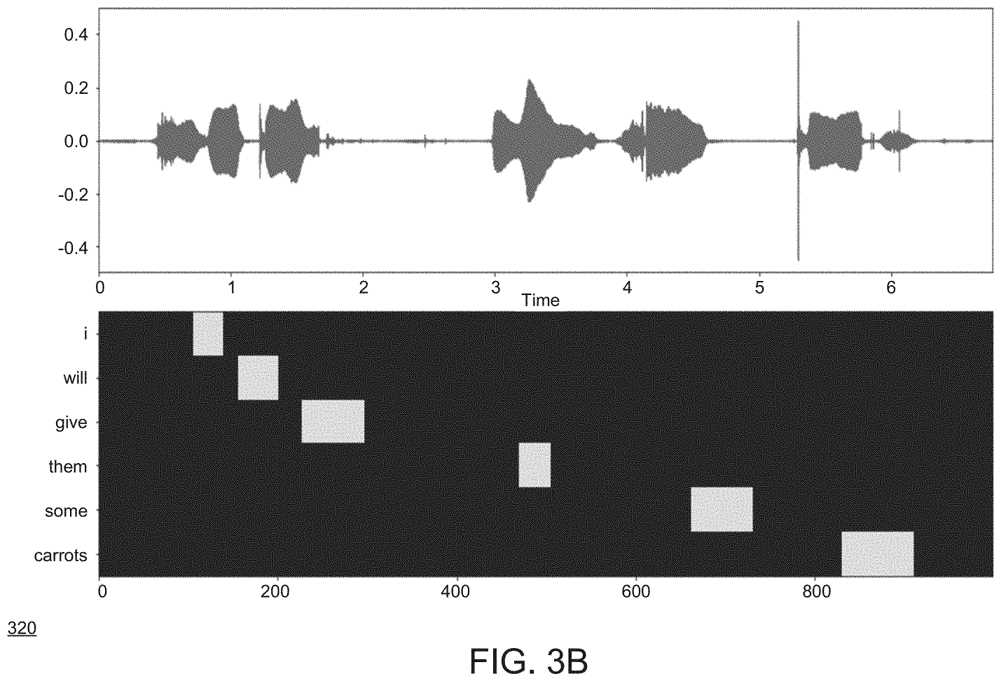

Processes in accordance with many embodiments of the invention can perform alignment and temporal resolution in two separate steps where a probability of the alignment of each target piece (e.g., each word) can be computed for one or more timesteps and temporal resolution can be performed to determine an overall alignment of target word pieces over the complete time range. An example of alignment and temporal resolution in accordance with various embodiments of the invention is illustrated in FIGS. 3A-B. The first stage 305 shows an alignment step, where audio 310 is aligned with alignment probabilities 315 for each of the target elements over a range of time, showing peaks for potential matches between the words and the audio. In this example, the alignment probabilities 315 include probabilities for each target element, including non-blanks, word separators, and individual words (e.g., “I”, “will”, “give”, “them”, “some”, “carrots”). The second stage 320 shows a temporal resolution step, where many possible alignments are used to determine a global alignment of the sequence of target words to the audio based on the alignment probabilities of 315. The second stage 320 shows a visualization of correspondence scores for keywords across time spans of audio data. FIG. 3B shows audio graph 325 of a portion of audio and a corresponding heatmap 330 indicating scores for each target element of a target sequence. In the heatmap of this example, each element of a target sequence is listed in order down the y-axis. Time runs along the x-axis. For each time span (e.g., for each encoded token) along the x-axis, lighter colors represent a higher score for that keyword for that time span.

a. Alignment

Alignment processes in accordance with certain embodiments of the invention can be performed to determine alignment probabilities or correspondence scores for each target element over a range of time.

The goal of the alignment step in accordance with a variety of embodiments of the invention is to compute a correspondence score for the probability

C(w,[tₛ,tₑ])≈Pr(w aligned to time [tₛ,tₑ])

for each target word (or word-piece) w given a time interval [tₛ, tₑ].

In some embodiments, the input to the alignment process is the output sequence of an acoustic model s₁, s₂, . . . , s_{T} over the audio input x₁, x₂, . . . , x_{T} where each sₜ∈[0,1]^{|V|} is a probability vector indicating the probability over all graphemes at a particular timestep for a given alphabet V.

i. Fixed Buffer Keyword Spotting Methods

In some embodiments, methods inspired by keyword spotting may be utilized to compute the probability of a single word occurring in a buffer of grapheme token probability vectors covering many timesteps. A single buffer size t_{Buffer} can be fixed and, at each step, the probability of w occurring within the buffer can be computed. Because learning readers often produce additional sounds or speech with their reading and because the buffer may include multiple targets in this setup, the probability of the wildcard sequence p(*w*|sₜ₋ₜ_{_{Buffer}}, . . . , sₜ) can be computed in order to account for arbitrary insertions before and after w. Processes in accordance with some embodiments of the invention may compute probabilities over CTC tokens using dynamic programming as described in Lengerich & Hannun “An end-to-end architecture for keyword spotting and voice activity detection” NIPS Speech Recognition Workshop, 2016, the disclosure from which is hereby incorporated by reference in its entirety.

ii. Explicit Alignment Maximization Methods

In some embodiments, A(w,[tₛ,tₑ]) can be computed for all possible intervals [tₛ, tₑ] (or a large sample of them) by identifying, for each interval, the best possible alignment π* of w to sₜ_{ₛ}, sₜ_{ₑ} that maximize the probability

$$P ( w \vert {s}_{{t}_{s}} , … , {s}_{{t}_{e}} ) = {max}_{π ∈ 𝒜 ( w )} {\prod }_{t = {t}_{s}}^{{t}_{e}} {s}_{t} ( {π}_{t} ) = {max}_{π ∈ 𝒜 ( w )} {\prod }_{t = {t}_{s}}^{{t}_{e}} p ( {π}_{t} \vert {x}_{t} )$$

and then deriving a composite score based on this formula. Above, [symbol] (w) denotes all possible ways of aligning the graphemes to produce a sequence consistent with w (within tₑ-tₛ steps), which may include repetitions of graphemes or blank/transition graphemes (e.g., one possible alignment for the word “bunny” in twelve timesteps may be “b b∈u u∈n∈n n∈y”, where ∈ denotes the blank/transition token in the alphabet). While there are exponentially many possible alignments, the π* that maximizes the probability can be computed efficiently, for example in a linear-time dynamic programming algorithm operating in log space that solves

$${π}^{*} = arg {max}_{π ∈ 𝒜 ( w )} {\sum }_{t = {t}_{s}}^{{t}_{e}} log {s}_{t} ( {π}_{t} ) .$$

In numerous embodiments, processes that solve for π* can build, for each tₛ, an alignment matrix m′ initialized to −∞ where m′ₜⱼ indicates the maximum cumulative log probability sum attainable by having transitioned to the jth grapheme of w by time tₛ+t. The final column of m′ would then define the maximum probability log probability associated with aligning w to the interval [tₛ, tₛ+0], [tₛ, tₛ+1], [tₛ, tₛ+2], . . . , and so on. Processes in accordance with a variety of embodiments of the invention can be easily extended to an online setting by caching rows of m′. Depending on the nature of the model that produces the token sequence s, processes can account for special tokens differently. Using CTC embeddings, processes in accordance with several embodiments of the invention may allow skipping the blank token E between graphemes or enforce a transition or repetition character between them consistent with the training procedure for the model that produced the sequence.

iii. Template Matching Methods

In some embodiments, the input to the alignment process may be a sequence of embedding vectors s₁, s₂, . . . , s_{T}, where each sᵢ∈ [symbol] ^{d} is a d-dimensional embedding vector and target words can be scored using template matching to measure the similarity of a section of input sample audio with a template for a portion of audio known to contain a target word. Templates in accordance with various embodiments of the invention can be computed over encoded audio data. Embedding vectors representing encoded audio data in accordance with certain embodiments of the invention can include grapheme probability vectors (as described above) or other representations of the audio signal, including (but not limited to) the raw signal, derived features such as MFCCs, neural network representations (such as the hidden states or memory states of an LSTM), neural embeddings derived from the network, or any other numerical embeddings. In some embodiments, multiple types of embeddings may be used (e.g. through concatenation or separate scoring) in a hybrid system that combines multiple methods.

In some embodiments, the template for a portion of audio known to contain a target word can be created using template averaging with time warping, where multiple templates are aligned as best as possible, e.g., using a Dynamic Time Warping (DTW) algorithm. Template averaging in accordance with a number of embodiments of the invention can allow for systems to generalize across different speakers. At inference time, dynamic time warping can be used to calculate the match of one or more templates of fixed length with a token-probability-vector or embedding-vector sequence sₜ_{ₛ}, . . . , sₜ_{ₑ} of length tₑ-tₛ. Dynamic time warping in accordance with several embodiments of the invention can be performed in two steps: first the optimal alignment is identified and then a composite score is computed over that alignment, generally both using the same distance metric.

In a variety of embodiments, template matching can utilize various common mathematical distance metrics to compute the match signal. Generally, when using embedding vectors, geometric distances (e.g., cosine similarity, Euclidean distance, inner product, etc.) can be appropriate. When using probability vector sequences, distribution distance metrics can be appropriate (e.g., Kullback-Leibler divergence (KL), Wasserstein Distance, Hellinger distance, total variational distance (TVD), etc.). However, any suitable distance metric may be applied to any form of embedding templates to maximize empirical performance. In some embodiments, rather than computing a single template, a template covariance matrix can be computed so that a variance-aware out-of-distribution test can be performed for the distance metric in template matching, for example using the Mahalanobis distance. In order to derive a correspondence score, the distance signal can be aggregated temporally. In some embodiments, this aggregation can be performed in various ways, such as (but not limited to) taking the sum, the max, and/or a smooth max signal such as the LogSumExp of the individual distances after time-warping.

b. Normalization

Discriminative approaches in accordance with some embodiments of the invention produce a signal for the probability that the target word(s) (or phonetic sequence) w is contained in a given interval sₜ_{ₛ}, . . . , sₜ_{ₑ}. In some embodiments, the probability signals described can be directly employed as confidence estimates. However, it can often be beneficial to perform additional normalizations to derive a correspondence score that accounts for various confounding factors such as (but not limited to) the length of w, various neural network modeling dynamics, and/or the differing ease with which learning readers are able to pronounce different words (or phonetic sequences) w such that the model produces output sequences that contain an alignment for w with high probability, etc. Normalizing in accordance with numerous embodiments of the invention can be based on various characteristics, such as (but not limited to) target word length, the number of non-blank predictions, alignment with a sequence of target words, etc. Processes in accordance with certain embodiments of the invention can normalize correspondence scores using various normalization methods. Processes in accordance with certain embodiments of the invention may utilize normalizations for information content and/or empirical normalization techniques. Normalization values in accordance with some embodiments of the invention can be computed using validation data.

The main need for information content normalizations arises from the fact that the probability signals underlying the correspondence scores are often multiplicative and decrease quickly. For example, using (1) fixed buffer keyword spotting probability p(*w*|sₜ₋ₜ_{_{Buffer}}, . . . , sₜ) or (2) the explicit max alignment probability

$${max}_{π ∈ 𝒜 ( w )} {\prod }_{t = {t}_{s}}^{{t}_{e}} p ( {π}_{t} \vert {x}_{t} ) ,$$

it is observed that with increasing length |w|, more probabilities are multiplied together. Similarly, for slower (but perhaps no less accurate) readers, more probability terms that correspond to grapheme repetitions of w can be accumulated in the optimal alignment sequence π*, thus yielding a lower probability score. Multiple approaches are proposed in the literature to normalize for the length of |w| and/or conversely the information content of s. For example, Bluche et al. 2020 in “Small-Footprint Open-Vocabulary Keyword Spotting with Quantized LSTM Networks” proposed normalizing correspondence scores in log-space for keyword spotting by the length of sₜ_{ₛ}, . . . , sₜ_{ₑ} given by tₑ-tₛ or by the amount of non-blank probability weight contained in the probability vector sequence denoted by Σₜ₌ₜ_{ₛ}^{t}^{ₑ}(1−sₜ(∈)) in the present notation. Processes in accordance with some embodiments of the invention may perform normalization as described in Bluche et al. 2020 in “Small-Footprint Open-Vocabulary Keyword Spotting with Quantized LSTM Networks”, the disclosure from which is hereby incorporated by reference in its entirety.

An example correspondence score in accordance with some embodiments of the invention using explicit alignment maximization is thus given by

$${A}_{1} ( w , [ {t}_{s} , {t}_{e} ] ) = {Σ}_{t = {t}_{s}}^{{t}_{e}} ( 1 - {s}_{t} ( ϵ ) ) \sqrt{{max}_{π ∈ 𝒜 ( w )} {\prod }_{t = {t}_{s}}^{{t}_{e}} {s}_{t} ( {π}_{t} )} = exp ( \frac{{Σ}_{t = {t}_{s}}^{{t}_{e}} log {s}_{t} ( {π}_{t}^{*} )}{{Σ}_{t = {t}_{s}}^{{t}_{e}} ( 1 - {s}_{t} ( ϵ ) )} ) .$$

Such a correspondence score can operate well in practice for a signal that is known to contain speech. However, the correspondence score A₁ derived in this way may suffer from an inherent problem with handling blank input: because the denominator still attributes some weight to a blank match, the system can attain a relatively high correspondence score over a sequence that includes an arbitrary long blank sequence. For example, the system may identify the word “|” spuriously in an empty sequence that does not contain any speech as a single low-probability grapheme for the i-character, followed by n ∈-tokens. If, for example, the match on each empty token was 0.8, which would be plausible if the sequence was indeed empty, the system could compute a correspondence score of exp

$$( \frac{log p ( {}_{}^{″}{I}{}_{}^{″} \vert {x}_{{t}_{s}} ) + n log ( 0.8 )}{( 1 - {s}_{{t}_{s}} ( ϵ ) ) + 0.2 n} ) .$$

For increasing n, the score would then approach exp

$$( \frac{log ( 0.8 )}{0.2} ) \approx 0.33$$

arbitrarily closely as long as the system could identify sufficient empty space. To correct for this, processes in accordance with some embodiments of the invention can restrict the normalization to those graphemes that are placed as non-blanks in the alignment by multiplying the indicator term [symbol] {πₜ*≠∈} with the sum in the denominator, yielding the following correspondence score:

$${A}_{2} ( w , [ {t}_{s} , {t}_{e} ] ) = exp ( \frac{{Σ}_{t = {t}_{s}}^{{t}_{e}} log {s}_{t} ( {π}_{t}^{*} )}{{Σ}_{t = {t}_{s}}^{{t}_{e}} ( 1 - {s}_{t} ( ϵ ) ) \cdot 𝕀 \{ {π}_{t}^{*} ϵ \}} ) .$$

Processes in accordance with a number of embodiments of the invention may perform normalization using a language model by computing a likelihood ratio between the probability of the target sequence and the probability of the most likely alternative transcription that is congruent with the language model. Such models may be desirable in order to spot common mistakes made by readers who read words that are plausible in context but incorrect. For example, in the excerpt from a children's book “I did find this pin. It has a nice shine,” a reader may read “pen” instead of “pin” and a language model is equivalently more likely to predict “pen” as the correct word because it is a more common word in the English language. Processes in accordance with certain embodiments of the invention may be designed to first identify the most probable grapheme sequence consistent with a language model LM for the entire token sequence ending with s_{T},

π^{LM}=arg max_{π}p(transcription collapsed from π|s₁, . . . ,s_{T},π,LM).

For example, processes in accordance with a number of embodiments of the invention can use various methods for decoding (e.g., beam search, finite state transducer decoding, etc.) and then use subsequences of π^{LM} for normalization, e.g.,

$${A}_{3} ( w , [ {t}_{s} , {t}_{e} ] ) = exp ( \frac{{Σ}_{t = {t}_{s}}^{{t}_{e}} log {s}_{t} ( {π}_{t}^{*} )}{{Σ}_{t = {t}_{s}}^{{t}_{e}} log {s}_{t} ( {π}_{t}^{LM} )} ) .$$

In some embodiments, the language model used for normalization may be augmented with words that are known to be common reading mistakes for the target sequence.

Even after normalizing for the information content contained in sₜ and the length of w, scoring for keywords can be biased toward shorter and more common words, word-pieces, or phrases. This may happen due to modeling effects that cause the acoustic model to effectively place a probabilistic prior on producing token sequences that are congruent with certain w, effectively acquiring a built-in language model during training. Processes in accordance with various embodiments of the invention can normalize for explicit model network dynamics that may be found in models that are trained with data in a given language as well as for differences in the ease of pronunciation of different words.

Normalization for such effects in accordance with various embodiments of the invention can identify an empirical normalizer for a given correspondence score [symbol] _{˜Validation data}[A(w, [tₛ, tₑ])] and then compute the ratio

$$\frac{A ( w , [ {t}_{s} , {t}_{e} ] )}{E [ A ( w , [ {t}_{s} , {t}_{e} ] ) ]}$$

as the normalized correspondence score. One or more heuristics can be employed to compute [symbol] [A(w,[tₛ,tₑ])] in accordance with numerous embodiments of the invention. For example, the maximum aligned score over all [tₛ, tₑ] within a small number of sequences that are known to contain w can be used to compute the normalization term in some embodiments. Using both positive and negative examples, processes in accordance with several embodiments of the invention can identify a threshold that best separates a series of maximized alignment scores over sequences that are known to contain w from scores derived from randomly selected sequences that are known not to contain w (a threshold can be identified, for example, using Youden's J statistic). When only negative examples are available for a given w, processes in accordance with a variety of embodiments of the invention may estimate a normalizer through regression using various data such as (but not limited to) the variance of the scores over the negative examples or the number and type of graphemes contained in w.

In a number of embodiments, processes can employ probability clamping to cap scores for target words. Clamping probabilities in accordance with some embodiments of the invention can be used to remove outlier scores caused by words that are rare or with low probabilities, causing the denominator [symbol] [A(w,[tₛ,tₑ])] to become very small.

In many embodiments, shorter words may be normalized through additional preprocessing since they often sound like portions of longer words and may thus be identified more eagerly. In several embodiments, processes can append a word separator character, such as a space to each target. Processes in accordance with a variety of embodiments of the invention can use the space to identify matching target words, while not including the space for scoring.

In many embodiments of the invention, several normalization procedures can be combined and used in combination with different raw probability signals. Conversely normalization steps may be omitted. For example, using only empirical normalization with a buffered keyword spotting signal can be given by

$${A}_{4} ( w , [ {t}_{e} - {t}_{Buffer} , {t}_{e} ] ) = \frac{p ( * w * \vert {s}_{{t}_{e} - {t}_{Buffer}} , … , {s}_{{t}_{e}} )}{𝔼 [ * w * \vert {s}_{{t}_{e} - {t}_{Buffer}} , … , {s}_{{t}_{e}} ) ]} .$$

To improve performance and robustness, processes in accordance with many embodiments of the invention can combine several different scoring mechanisms to arrive at a final score. For example, processes in accordance with various embodiments of the invention can perform an initial search using a grapheme probability vector sequence to identify candidates above a certain threshold A(w, [tₛ, tₑ])>τ, and then consider those subsequences for template matching on embeddings to compute a more robust correspondence signal for w in a likely interval. Such hybrid processes may use different types of embeddings for different subroutines.

c. Temporal Resolution

Temporal resolution can be employed to identify the position of a reader in a given piece of text and score their reading progress. In some embodiments, temporal resolution can be performed simply via a bag of words approach; rather than scoring based on fine-grained alignments for encoded audio sequences, processes in accordance with these embodiments of the invention can produce an aggregate position hypothesis based on the presence of words in the audio sequence, regardless of order or position. In a variety of embodiments, processes can determine the position within the target sequence based on various criteria, such as (but not limited to) a maximum number of words that can be skipped, a last word read, etc. For example, using the signal C₄, the system can continuously listen for all target words or a window of target words within a single buffer of grapheme probability vectors, and then advance the cursor as far as possible with the given constraints.

In several embodiments, when performing alignment online, processes can use multiple cursors to determine alignments of encoded audio and target sequences. Processes in accordance with several embodiments of the invention can evaluate multiple alignments beginning at different cursors to identify a desired alignment. Intuitively, a cursor becomes more likely to be the correct cursor when it continues moving—the reader may have skipped a word but if they then keep reading, it was likely a real skip. Some embodiments may restrict the number of cursors to a fixed number k and perform regular pruning to remove unlikely cursors. Beginning with a root cursor ϕ₀, the hypothesis can be split into cursors up to ϕ₀, . . . , ϕₖ₋₁. Applied to embodiments consistent with correspondence score A₄, for example, each cursor may be used to listen for a small number of words at a given point in time, effectively computing alignments and determining temporal resolution in unison. If the cursor observes a split, it can split into two or more hypothesis cursors, including one that follows the skip and one that remains in place. The score for a cursor may be computed as

score(ϕᵢ)=Σ_{j=1,j∉skipped(ϕ}_{ᵢ}₎^{ϕ}^{ᵢ}A₄(wⱼ)−βΣ_{j∈skipped(ϕ}_{ᵢ}₎(1−A₄(wⱼ)),

where skipped(ϕᵢ) denotes the set of indices that ϕᵢ considers skipped, A₄(wⱼ) is the score attained when the cursor was incremented, and β is a skipping penalty weight.

In other embodiments, temporal resolution can be done explicitly over all or some A(w, [tₛ, tₑ]) via exhaustive search in order to maximize the total probability sum. In some embodiments, each alignment can be identified as a non-overlapping sequence of the target words. Given l target words (or sequences), such embodiments may compute the best overall alignment tₛ₁, tₑ₁, . . . , tₛₗ, tₑₗ to maximize Σᵢ₌₁^{l} A(wᵢ, [tₛᵢ, tₑᵢ]), such that tₛᵢ>tₑ₍ᵢ₋₁₎∀i. In numerous embodiments, this can be implemented efficiently in a linear-time dynamic programming algorithm by defining a resolved score sum matrix m″ and such that m″ₜᵢ denotes the maximum probability sum attainable by having transitioned to the ith target by time t, and then computing entries of m one step at a time. The ith entry of the final row of m″ then indicates the sum of scores that can be attained by postulating that the reader completed the first i targets. In some embodiments, processes can be extended to keep track of the aligned probability scores that make up each score for each entry of m″ or each entry of the last row of m″.

In a variety of embodiments, processes can identify an alignment sequence that maximizes the probability sum of a keyword sequence according to several heuristic constraints. Constraints in accordance with a number of embodiments of the invention can include (but are not limited to) a number of words that can be skipped and/or missed, a penalty for skipping, etc. Alignments in accordance with numerous embodiments of the invention can be determined using both individual word alignment scores as well as a sequence alignment score. The use of such scores can allow for alignments that may be missing words or for alignments where words may be repeated, which is often the case for young readers.

In several embodiments, processes can either implicitly or explicitly identify anchor words in a text sequence, where each anchor point can be target words with high correspondence scores (or a max aligned peak score) greater than a threshold value. Anchor words in accordance with some embodiments of the invention can be used to supplement or normalize the analysis of target sequences by using different threshold values to identify the presence of expected target words between or surrounding the anchor words.

Rather than performing temporal resolution over all targets at all times, processes in accordance with various embodiments may limit the number of targets considered at any point in time for alignment and temporal resolution. Such processes may commit targets that have been read or skipped already and not perform further scoring on such targets. In numerous embodiments, limiting the number of target can be performed using a fixed sliding window that allows adjusting for adjusting the target position in the sequence alignment only for a limited period of time once its correspondence score has reached a threshold before finally committing the target.

Processes in accordance with a number of embodiments of the invention can derive a reading position estimate from an alignment sequence tₛ₁, tₑ₁, . . . , tₛₗ, tₑₗ, a total temporally resolved alignment score, multiple possible temporally resolved alignment candidates each with their own alignment sequence, and/or individual target alignment sub-scores based on a number of heuristics. In many embodiments, processes may compute an average score over a group of targets and advance the position if the average score reaches a certain threshold, thus implicitly modeling word skipping behavior like in a cursor model through a single threshold.

For the hypothesis that the sequence ends at the jth target, there exists a separate best alignment sequence ending at tₑⱼ. In some embodiments, scoring processes can apply heuristics to these sequences and then choose the furthest j for which all alignment sequences fulfil the heuristics. In some embodiments, scoring processes can form a delta score vector by taking the difference between a target's maximum accumulated sum score and the maximum sum score of its preceding target,

Δⱼ=max Σ_{i=1,t}_{ₛᵢ}_{>t}_{ₑ₍ᵢ₋₁₎}_{∀i}^{j}A(wᵢ,[tₛᵢ,tₑᵢ])−max Σ_{i=1,t}_{ₛᵢ}_{>t}_{ₑ₍ᵢ₋₁₎}_{∀i}^{j-1}A(wᵢ,[tₛᵢ,tₑᵢ]),

and identify the largest j fulfilling the scoring requirements over this vector directly. Intuitively, Δⱼ gives the contribution of including the jth target in the sequence over only including j−1 targets, adjusted for having to shift the preceding targets to fit the jth target. In a number of embodiments, the position can start out as 0 and can be incremented by 1 for j continuous steps as long as the mean delta score of any group of targets beginning at j and ending at a target to the right of j exceeds a threshold T. Intuitively, this simulates the cursor behavior by which words to the right of a target word can contribute to advancing the position over the target but words to its left cannot.

Although many of the examples described herein describe the use of tokens, one skilled in the art will recognize that similar systems and methods can be used in a variety of applications, including (but not limited to) with outputs of ASR-based methods, without departing from this invention.

While specific processes for determining alignments are described above, any of a variety of processes can be utilized to determine alignments between audio and text as appropriate to the requirements of specific applications. The alignment correspondence scores A₁, A₂, A₃, and A₄ are provided as examples, but many more correspondence metrics can be derived from the description above by combining different alignment and normalization techniques. Each such score can be combined with different temporal resolution processes, or multiple scores may be combined in a hybrid system. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

### C. Systems for Validating Speech

1. Speech Validation System

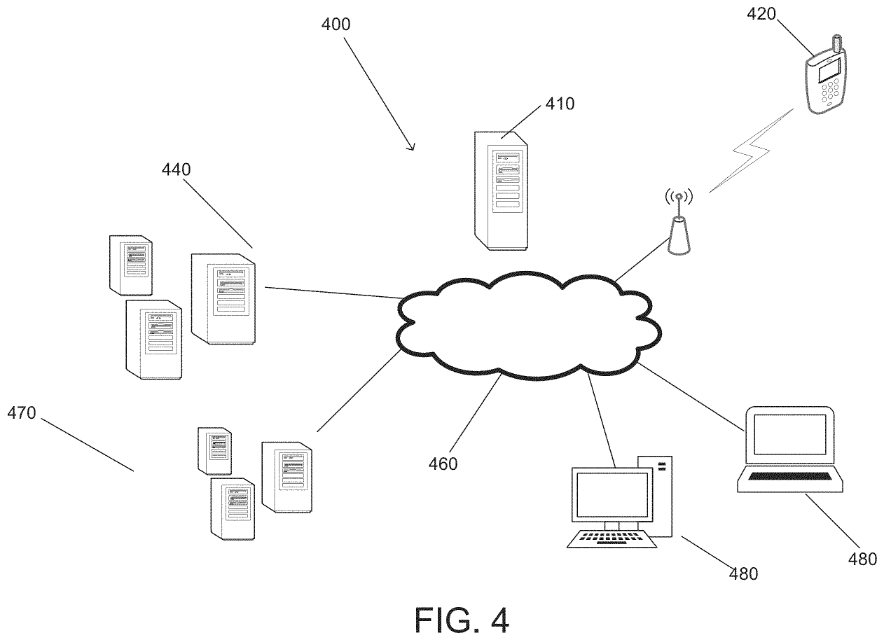

An example of a speech validation system that validates speech in accordance with an embodiment of the invention is illustrated in FIG. 4. Network 400 includes a communications network 460. The communications network 460 is a network such as the Internet that allows devices connected to the network 460 to communicate with other connected devices. Server systems 410, 440, and 470 are connected to the network 460. Each of the server systems 410, 440, and 470 is a group of one or more servers communicatively connected to one another via internal networks that execute processes that provide cloud services to users over the network 460. One skilled in the art will recognize that a speech validation system may exclude certain components and/or include other components that are omitted for brevity without departing from this invention.

For purposes of this discussion, cloud services are one or more applications that are executed by one or more server systems to provide data and/or executable applications to devices over a network. The server systems 410, 440, and 470 are shown each having three servers in the internal network. However, the server systems 410, 440 and 470 may include any number of servers and any additional number of server systems may be connected to the network 460 to provide cloud services. In accordance with various embodiments of this invention, a speech validation system that uses systems and methods that validate speech in accordance with an embodiment of the invention may be provided by a process being executed on a single server system and/or a group of server systems communicating over network 460.

Users may use personal devices 480 and 420 that connect to the network 460 to perform processes that validate speech in accordance with various embodiments of the invention. In the shown embodiment, the personal devices 480 are shown as laptop computers that are connected via a conventional “wired” connection to the network 460. However, the personal device 480 may be a desktop computer, a laptop computer, a smart television, an entertainment gaming console, or any other device that connects to the network 460 via a “wired” connection. The mobile device 420 connects to network 460 using a wireless connection. A wireless connection is a connection that uses Radio Frequency (RF) signals, Infrared signals, or any other form of wireless signaling to connect to the network 460. In the example of this figure, the mobile device 420 is a mobile telephone. However, mobile device 420 may be a mobile phone, Personal Digital Assistant (PDA), a tablet, a smartphone, or any other type of device that connects to network 460 via wireless connection without departing from this invention. In many embodiments, speech validation processes are performed entirely on a personal device of a user, allowing for minimal latency and to ensure the user's privacy.

As can readily be appreciated the specific computing system used to validate speech is largely dependent upon the requirements of a given application and should not be considered as limited to any specific computing system(s) implementation.

2. Speech Validation Element

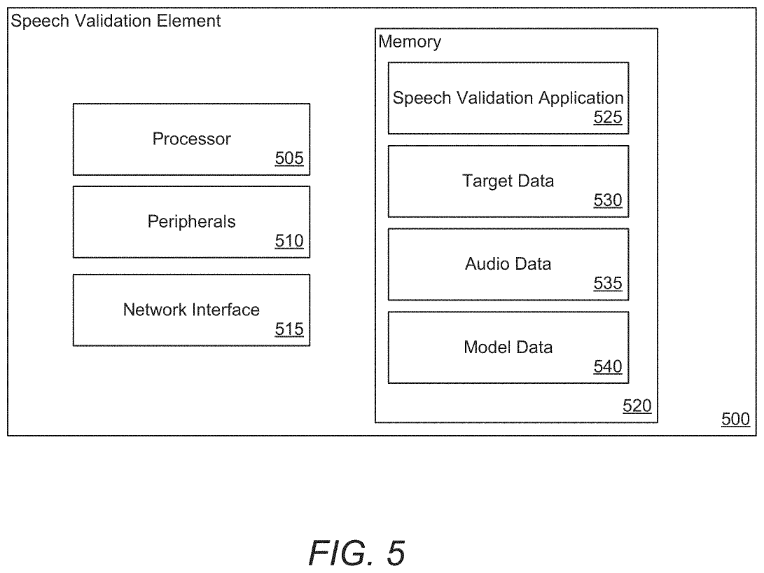

An example of a speech validation element that executes instructions to perform processes that validate speech in accordance with an embodiment of the invention is illustrated in FIG. 5. Speech validation elements in accordance with many embodiments of the invention can include (but are not limited to) one or more of mobile devices, cameras, and/or computers. Speech validation element 500 includes processor 505, peripherals 510, network interface 515, and memory 520. One skilled in the art will recognize that a speech validation element may exclude certain components and/or include other components that are omitted for brevity without departing from this invention.

The processor 505 can include (but is not limited to) a processor, microprocessor, controller, or a combination of processors, microprocessor, and/or controllers that performs instructions stored in the memory 520 to manipulate data stored in the memory. Processor instructions can configure the processor 505 to perform processes in accordance with certain embodiments of the invention. In various embodiments, processor instructions can be stored on a non-transitory machine readable medium.

Peripherals 510 can include any of a variety of components for capturing data, such as (but not limited to) microphones, cameras, displays, and/or sensors. In a variety of embodiments, peripherals can be used to gather inputs and/or provide outputs. Speech validation element 500 can utilize network interface 515 to transmit and receive data over a network based upon the instructions performed by processor 505. Peripherals and/or network interfaces in accordance with many embodiments of the invention can be used to gather inputs that can be used to validate speech.

Memory 520 includes a speech validation application 525, target data 530, audio data 535, and model data 540. Speech validation applications in accordance with several embodiments of the invention can be used to validate speech using various processes as described in this specification.

Target data in accordance with some embodiments of the invention can include text sequences or phonetic transcriptions associated with the audio data. Target sequences in accordance with many embodiments of the invention can include text for a whole book, a chapter, a paragraph, a sentence, an individual word, a component of a word, a phoneme, etc. In certain embodiments, target data can include various text associated with audio, such as (but not limited to) transcripts, scripts, closed captions, etc.

In many embodiments, audio data can include (but is not limited to) raw audio data, feature vectors derived from audio data, such as mel-frequency cepstral coefficients (MFCC), spectrogram data, neural embeddings (e.g., from a convolutional encoder network), etc. Audio data in accordance with numerous embodiments of the invention can include recordings of a reader that can be evaluated based on the target data. Audio data in accordance with many embodiments of the invention can be captured and processed in an online process as feedback is provided to a reader as they proceed through the target data.

In several embodiments, model data can store various parameters and/or weights for various models that can be used for various processes as described in this specification. Model data in accordance with many embodiments of the invention can be updated through training on audio and target data captured on a speech validation element or can be trained remotely and updated at a speech validation element.

Although a specific example of a speech validation element 500 is illustrated in this figure, any of a variety of speech validation elements can be utilized to perform processes for validating speech similar to those described herein as appropriate to the requirements of specific applications in accordance with embodiments of the invention.

3. Speech Validation Application

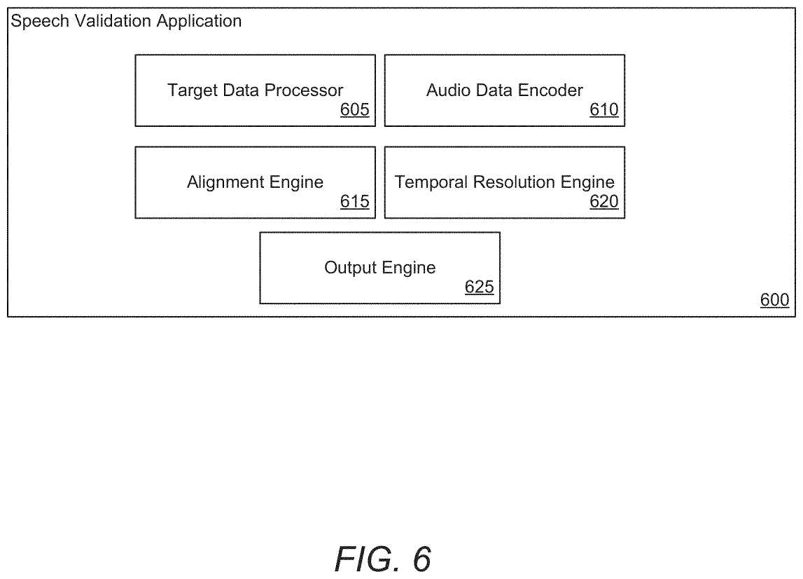

An example of a speech validation application for validating speech in accordance with an embodiment of the invention is illustrated in FIG. 6. Speech validation application 600 includes target data processor 605, audio data encoder 610, alignment engine 615, temporal resolution engine 620, and output engine 625. One skilled in the art will recognize that a speech validation application may exclude certain components and/or include other components that are omitted for brevity without departing from this invention.

Target data processors in accordance with various embodiments of the invention can process (or encode) target data by transforming the data into a different alphabet over which alignment can be performed. In some embodiments, target data can be converted between representations of language (e.g., between phonetic representations and character representations). Target data processors in accordance with numerous embodiments of the invention can utilize phoneme dictionaries and/or phonetic decoders to transform characters into phonemes or other graphemes (e.g., combinations of phonemes).

In a variety of embodiments, audio data encoders can convert raw audio data to various representations, including (but not limited to) feature vectors derived from audio data, mel-frequency cepstral coefficients (MFCC), spectrogram data, neural embeddings, etc. Encoding audio data in accordance with numerous embodiments of the invention may also include normalizing words, performing certain pruning removing punctuation and/or stopwords, and/or other common pre-processing tasks. Audio data encoders in accordance with some embodiments of the invention can include (but are not limited to) recurrent neural networks (RNNs) such as long short-term memory (LSTM) models or models using gated recurrent units (GRUs), transformer models, fully or partially convolutional neural networks (CNNs), etc.

Alignment engines in accordance with a number of embodiments of the invention can compute alignment probabilities for individual targets. In many embodiments, computing alignment probabilities can identify targets in the temporal sequence. Temporal probability output vectors (or tokens) in accordance with many embodiments of the invention can indicate probabilities for each element of an alphabet at various time steps. Alignment engines in accordance with a number of embodiments of the invention can include (but are not limited to) neural networks trained using Connectionist Temporal Classification (CTC) or the Audio Segmentation Criterion (ASG) or Hidden Markov Models (HMMs) with explicit alignment.

In certain embodiments, temporal resolution engines can use individual word alignments to determine an alignment of the sequence of target words to the audio data. Temporal resolution can be employed to identify the position of a reader in a given piece of text and score their reading progress.

Output engines in accordance with several embodiments of the invention can provide a variety of outputs to a user, including (but not limited to) predicted position within the text, target probabilities, measurements of vocal activity, reading scores, etc. In a number of embodiments, output engines can provide outputs to a graphical user interface (GUI) to provide assistance to a reader as they read text. Output engines in accordance with numerous embodiments of the invention can provide various interfaces to a user based on the generated outputs, such as (but not limited to) position guidance, focused exercises for problem words, interactive read along experiences, extension content, etc.

Although a specific example of a speech validation application is illustrated in this figure, any of a variety of speech validation applications can be utilized to perform processes for validating speech similar to those described herein as appropriate to the requirements of specific applications in accordance with embodiments of the invention. Although various functions are described with reference to discrete engines and/or components, one skilled in the art will recognize that various functions may be performed by more or fewer components. For example, speech validation applications in accordance with various embodiments of the invention may use an end-to-end model to combine the functionalities of alignment and temporal resolution engines.

Although specific methods of validating speech are discussed above, many different methods of validating speech can be implemented in accordance with many different embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A method for validating speech, the method comprising:
encoding a set of audio data;
processing a set of target data, wherein the target data comprises a sequence of target elements associated with the set of audio data;
computing a set of one or more alignment probabilities for each target element of the sequence of target elements; and
performing temporal resolution based on the computed set of alignment probabilities to determine an alignment between the set of target data and the set of audio data.

2. The method of claim 1, wherein processing the set of target data comprises transforming the set of target data from character representations to phonetic representations by least one selected from the group consisting of performing a lookup in a phoneme dictionary.

3. The method of claim 1, wherein each target element of the set of target elements is a word and computing the set of alignment probabilities for each target element comprises computing temporal probability output vectors for each word.

4. The method of claim 1, wherein computing the set of alignment probabilities further comprises:
computing a set of correspondence scores; and
normalizing the computed set of correspondence scores by:
normalizing for information content; and
performing empirical normalization based on a set of validation data.

5. The method of claim 1, wherein computing the set of alignment probabilities comprises:
using a single fixed buffer to compute a probability of a set of one or more words occurring in the buffer for each of a plurality of timesteps;
identifying a set of positive examples; and
performing empirical normalization based on the set of positive examples.

6. The method of claim 1, wherein computing the set of alignment probabilities comprises:
building a matrix, wherein a part of the matrix defines the maximum probability log probability associated with aligning a target element to an interval; and
computing the maximum cumulative log probability sum for transitions each of a plurality of components at each of a plurality of time steps, wherein the plurality components comprises at least one of graphemes and phonemes.

7. The method of claim 1, wherein computing the set of alignment probabilities comprises using a template matching process to measure the similarity of a section of the audio data with a template for audio data known to contain a target word.

8. The method of claim 1, wherein computing the set of alignment probabilities comprises:
identifying target elements of the target sequence as blanks and non-blanks; and
performing normalization through a summation of values, where the sum only includes target elements of the sequence of target elements that are identified as non-blanks.

9. The method of claim 1, wherein computing the set of alignment probabilities comprises computing a likelihood ratio between a probability of the sequence of target elements and a probability of a most likely alternative transcription based on a language model.

10. The method of claim 1, wherein computing the set of alignment probabilities comprises:
appending a separator character to each target element of the sequence;
matching target elements with the encoded data based on the separator character; and
computing a score for each target element, wherein the computed score does not include the separator character.

11. The method of claim 1 further comprising normalizing the computed set of alignment probabilities by normalizing for based on at least one selected from the group consisting of target word length, non-blank predictions, and a best alternative transcription identified with a language model.

12. The method of claim 1 further comprising normalizing the alignment score between the set of target data and the set of audio data using a language model by computing a likelihood ratio between the probability of the target sequence and the probability of the most likely alternative transcription that is congruent with the language model.

13. The method of claim 1, wherein performing temporal resolution comprises determining alignments of encoded audio and the sequence of target elements using a plurality of cursors at different positions in the sequence of target elements.

14. The method of claim 1, wherein performing temporal resolution comprises:
identifying a set of one or more anchor elements from the sequence of target elements based on the set of alignment probabilities, wherein the anchor elements have higher correspondence scores than non-anchor elements; and
identifying an alignment of the sequence of target elements based on the set of anchor elements.

15. The method of claim 1, wherein performing temporal resolution comprises resolving a position estimate by:
computing a normalized score sum for each of a plurality of potential positions in the set of target data, where each normalized score is normalized by the particular potential position; and
identifying an alignment that corresponds to a highest normalized score sum of the computed score sums for the largest potential position that brings the score above a certain threshold.

16. The method of claim 1, wherein processing the set of target data comprises defining a decoding grammar over the encoded set of audio data to generate a set of predicted words, wherein defining the decoding grammar is performed utilizing a set of one or more Finite State Transducers (FSTs) comprising at least one FST graph that describes the probability of transitioning from one state to another state given at least a portion of the encoded set of audio data and an acceptor that encodes a grammar.

17. The method of claim 16, wherein the acceptor comprises a graph with at least two partitions, wherein a first partition proceeds through the targets in order with high probability and a second partition proceeds through alternative incorrect words.

18. The method of claim 16, wherein computing the set of alignment probabilities comprises creating a mapping between the predicted words and the target elements using a fuzzy string similarity metric to find a best match between the predicted words and the target elements.

19. A non-transitory machine readable medium containing processor instructions for validating speech, where execution of the instructions by a processor causes the processor to perform a process that comprises:
encoding a set of audio data;
processing a set of target data, wherein the target data comprises a sequence of target elements associated with the set of audio data;
computing a set of one or more alignment probabilities for each target element of the sequence of target elements; and
performing temporal resolution based on the computed set of alignment probabilities to determine an alignment between the set of target data and the set of audio data.

20. A system for validating speech, the system comprising:
a set of one or more processors; and
a non-transitory machine readable medium containing processor instructions for validating speech, where execution of the instructions by the set of processors causes the processor to perform a process that comprises:
encoding a set of audio data;
processing a set of target data, wherein the target data comprises a sequence of target elements associated with the set of audio data;
computing a set of one or more alignment probabilities for each target element of the sequence of target elements; and
performing temporal resolution based on the computed set of alignment probabilities to determine an alignment between the set of target data and the set of audio data.
